(19) United States
(12) Patent Application Publication
(10) Pub. No.: US 2006/0161335 A1
(43) Pub. Date: Jul. 20, 2006

(54) Routing system and method

(76) Inventor: Ross Beinhaker, Cambridge, MA (US)

Correspondence Address: WOOD, NGO & EISENBERG, PLLC, 2121 Eisenhower Ave, Suite 200, Alexandria, VA, 22314, US

(21) Appl. No.: 11/034,874

(22) Filed: Jan. 14, 2005

(51) Int. Cl. G01C 21/36

(52) U.S. Cl. 701/200; 701/117; 701/201

(57) ABSTRACT

The routing system and method find efficient routings among destinations in a traffic network. A starting point and at least one destination point are identified in the traffic network. The identified points are ordered into at least one tour. Traffic conditions for the traffic network are forecast for a time period of interest, and for each tour, a routing is generated using the forecast traffic conditions. A routing system implementing the method described in a computer or Internet environment includes a database storing a representation of the traffic network. A computer program provides means for selecting a starting point and at least one destination point in the traffic network, means for ordering the points into at least one tour, means for forecasting traffic conditions for the roads in the traffic network, and means for generating a routing for each tour using based on the forecast traffic conditions.

### BACKGROUND OF THE INVENTION

1. Field of the Invention

The present invention relates to the field of vehicular traffic modeling and routing and, more specifically, to a routing system and method for determining one or more ordered tours of a plurality of nodes in a traffic network, forecasting traffic conditions on arcs connecting the nodes, and using the forecast traffic conditions to determine optimal routings to travel among the nodes of the ordered tours.

2. Description of the Related Art

Vehicle routing and traffic forecasting systems are used to provide vehicle operators with information to help optimize a vehicle trip, such as by identifying a shorter, faster, or safer route, or identifying areas of a traffic network that are best avoided due to heavy traffic or an accident or the like.

Simple vehicle routing systems employ a shortest route or shortest path algorithm to determine a routing between a place of origin and a destination. Mathematically, shortest path algorithms typically view a road network as a set of nodes N interconnected by a set of arcs A. Each of the arcs (i, j) in A has associated with it a “cost” of traversing the arc, such as a distance or time required to traverse the arc. A path from the origin to the destination is a set of arcs (i₁, i₂, . . . , iₖ) that can be traversed from the origin to the destination. The shortest path algorithm traverses the arcs to find the set of arcs that connect the origin and destination with the lowest “cost”.

According to a conventional class of algorithms, nodes in the network are labeled, such that each node's label, upon completion of the algorithm, identifies the ”predecessor” arc upon completion of the algorithm, or the arc leading to the node along the shortest path from the origin to the node, and the distance from the origin to the node. At the outset of the algorithm, the distance label for each node is set to infinity, except the origin is set to zero (0). A set of nodes referred to as the “candidate list” is initialized to contain only the origin. As the algorithm progresses, a node is removed from the candidate list (the current node), and each arc outgoing from the node is checked. For each outgoing arc, if the distance established to the current node, plus the arc length, is less than the distance label for the node at the terminal end of the arc, the node is added to the candidate list. The algorithm iterates until the candidate list is empty.

Once the candidate list is empty, and the algorithm completed, the distance from the origin to each node in the network is known. To find the optimum path for any node in the network chosen as the destination, the path is found by simply “backtracking” along the predecessor arc from the destination node to each preceding node in the path by following the predecessor arc label for each node encountered.

Different shortest path algorithms are distinguished primarily by the method of selecting the node to exit the candidate list at each iteration of the algorithm. In one class, known as label setting or Dijkstra methods, the node exiting the candidate list is a node whose label is the minimum among all other nodes in the candidate list. In label setting methods, where all arc lengths are nonnegative, N iterations are required and each node (other than the origin) enters and exits the candidate list exactly once.

In another class of algorithms, known as label correcting methods, the selection of the node to be removed from the candidate list is faster than in label setting methods, but at the expense of multiple entrances of nodes onto the candidate list. The candidate list is maintained as a queue, and at each iteration the node at the top of the queue is removed. Various label correcting methods differ in how a node to be added to the candidate list is positioned within the queue.

In another class of algorithms, known as A* search methods, a heuristic is used to rank each node by an estimate of the best path that goes through that node. The algorithm then visits the nodes in the order of this heuristic estimate. The A* algorithm is, therefore, an example of a best-first search.

It can be recognized that shortest path algorithms may be employed with arcs measured in distance, or with arcs measured in travel time, since travel time is a simple function of distance and speed of travel along the arc. It is necessary, of course to know the travel speed for an arc, using either a real-time measurement or an estimation. A simple estimation of travel speeds along the arcs in a road network might be to simply assume that the posted speed limit for each of the arcs or road segments represents the actual travel speed. However, given variations that will be encountered during actual travel of the road segments, including traffic volumes, weather conditions, and accidents that all effect the speed of travel of vehicles along the road segments, such a simple estimation is not likely to consistently correspond usefully to actual conditions.

Various systems and methods are known for measuring and forecasting traffic conditions on roadways. Among traffic measuring systems are “spotter” systems wherein a person or persons report traffic conditions or incidents to a public forum, such as a radio or television news outlet, for dissemination. More advanced traffic measuring systems employ sensors on and around roadways, including video cameras, sensors embedded in roadways, and various telemetry systems using cellular or mobile telephony or other wireless means to relay information gathered by vehicles in real-time. While traffic measuring systems provide a useful present view of traffic conditions on measured roadways, and can be used to inform drivers in their vehicles by wireless delivery, such information may be of limited value to the task of vehicle routing. Because at least a portion, if not all, of a planned vehicle route will inherently be traveled at some time in the future, the use of present traffic conditions in determining the route likely produces no better a result than the use of a simple estimation of future traffic conditions.

Various methods for forecasting future traffic conditions employ a predictive model that uses current and historical information about traffic conditions to predict actual conditions that will occur in the future. Dynamic traffic assignment models and time-series analysis are two of these forecasting methods. With forecast traffic conditions available to incorporate into a routing algorithm, however, the complexity of the algorithm, and thus the computing power required to reach an adequate solution, increases greatly. It can be readily appreciated that a shortest path algorithm becomes much more difficult and time-consuming to solve when the “cost” of each arc varies according to its use in time, as determined by its position within any proposed route.

A specialized problem in routing exists when it is desired to generate a route among several “destinations”, such as customers on a delivery route, rather than a route from a single origin to a single destination. Unique among a delivery routing is that a delivery route, referred to as a “tour” in this context, generally begins and ends at the same point, such as a warehouse or depot. While the problem can be broken down into a number of origin/destination pairs representing the routes between the depot and the first customer, the first and second customers, and so forth, it is necessary first to establish an ordering of the customers for delivery. When capacity of the delivery vehicle, or other constraints, are considered, an optimal ordering of customers for a delivery tour may not be the shortest path connecting all customers, since an efficient ordering in light of the vehicle's capacity may include returns to the warehouse or depot to reload the vehicle.

There are various methods for efficiently ordering destinations among tours that are subject to certain constraints. Two exact approaches, known as “branch and cut” and “branch and bound”, use a divide and conquer strategy to partition the entire subspace into smaller problems for optimization. Exact approaches require a great deal of computing time for modest to large sized problems. To speed processing time up, several meta-heuristic approaches can be employed, including: ant algorithms, constraint programming, annealing, genetic algorithms, and tabu searches. Meta-heuristic approaches increase computing speed by only exploring the most promising regions of the solution space, and therefore are potentially sub-optimal.

A routing system and method that can create an efficient ordering of customers on one or more delivery tours and, using forecast traffic information, optimize routings between the customers based on forecast future traffic conditions, would improve productivity and reliability of transportation practices in commercial, governmental, and fleet vehicle routing. Thus, a routing system and method solving the aforementioned problems is desired.

### SUMMARY OF THE INVENTION

The routing system and method of the present invention provides for routing of vehicles using traffic information, geographic spatial databases, and novel methods. The system and method improves productivity and reliability of transportation practices in commercial, governmental, and other individual or fleet vehicle routing scenarios. The system and method includes elements for 1) determining the order of destinations, in a transportation network, to visit; 2) forecasting the state of the transportation network at relevant times in the future; and 3) determining optimal routings between destinations.

Ordering of the destinations initially is performed in view of a capacity constraint, such as a delivery vehicle capacity, that might require a return to the starting point before all destinations have been visited. From a list of multiple destinations, one or more “tours”, as necessary to meet the capacity constraint, are identified and ordered for efficient travel to all of the destinations. Note that the term ”tour” is used to designate a route that includes one or more destinations other than the origin. A tour generally begins and ends at the same point.

From an initial, random ordering of all destinations, a first initial tour is generated by adding a destination to the tour until the capacity constraint is met. If the capacity constraint is met without including all destinations, a second initial tour is generated from the remaining destinations, again subject to the capacity constraint. Thus, it can be seen that one or more initial tours are generated as an initial solution.

After the initial solution is found, an iterative improvement algorithm is used to identify improvements to the initial solution. The algorithm involves exchanging positions in the ordering of destinations, evaluating an objective function to determine if the new ordering produces an improvement, and re-evaluating the capacity constraint to make sure that the new ordering is feasible. The exchange may trade positions of destinations within a tour, or may switch destinations between tours.

The goal of the improvement algorithm is not to find an optimal solution to this ordering problem, given the processing overhead that would be required to find a true optimal solution. Instead, the result of the improvement algorithm is a “good” solution that is potentially close to optimal, and is achieved quickly and with a lower processing overhead requirement.

After generating the tours, future traffic conditions are forecast for the traffic network, using a time series forecasting method, to determine travel times for each of the roadways, or arcs, in the traffic network. The final routing solution uses the forecast travel times to generate optimal routes between the points along each tour.

The routing between each of the points of the tours is determined by applying a shortest path algorithm to each pair of points along the tour (origin to first destination, first destination to second destination, and so forth). The shortest path algorithm utilizes a label correcting method, wherein a cost or traffic parameter label for each arc is derived from the forecast travel time for the arc based on an actual planned travel time.

The method for routing is implemented in an Internet based architecture whereby traffic management systems and data are available, along with software components performing the various algorithms and methods, to deliver a vehicle routing service to users through Internet and World Wide Web connectivity. In addition, the routing service can be delivered to in-vehicle navigation systems, cellphones, handheld computers, or other mobile devices.

These and other aspects of the present invention will become readily apparent upon further review of the following specification and drawings.

### BRIEF DESCRIPTION OF THE DRAWINGS

FIG. 1 is a flowchart of a routing method according to the present invention.

FIG. 2 is a diagram of a traffic network showing two tours traversing several destinations.

FIG. 3 is a flowchart describing a method for finding one or more tours in a traffic network in consideration of a capacity constraint.

FIG. 4 is a flowchart of a tabu search algorithm for improving an ordering of destinations in a traffic network.

FIG. 5 illustrates multiple time series of intervals of measured or predicted traffic conditions.

FIG. 6 is a flowchart of a method for forecasting travel conditions in a traffic network.

FIG. 7 is a flowchart of a method for finding a fastest route between two route points in a traffic network, using forecasted traffic conditions.

FIG. 8 is a block diagram of a system architecture for a computer network system embodying a routing system according to the present invention.

Similar reference characters denote corresponding features consistently throughout the attached drawings.

### DETAILED DESCRIPTION OF THE PREFERRED EMBODIMENT

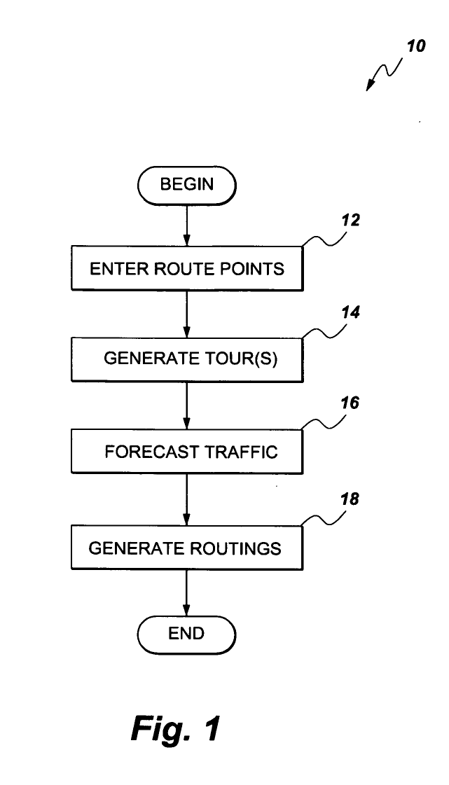

The present invention is a routing system and method for determining an efficient ordering of multiple destinations, and generating optimal routings between the multiple destinations based on forecast traffic conditions in a traffic network. Referring to FIG. 1, an overview of a routing method 10 according to the present invention is illustrated. The routing method 10 of the present invention involves, briefly, entry of one or more destinations (i.e., at least one destination) in a traffic network, such as customers on a delivery route (step 12). One or more tours are generated, based on a capacity constraint such as the cargo capacity of a delivery truck, to reach each of the destinations (step 14). With the tours generated, traffic conditions, such as travel times along the roadways in the travel network, are forecast for the time periods during which the destinations will be visited (step 16). With the travel conditions forecast, optimal routings between the destinations of each of the tours can be generated for the actual time of day that each of the roadways will be traveled in order in each of the tours (step 18).

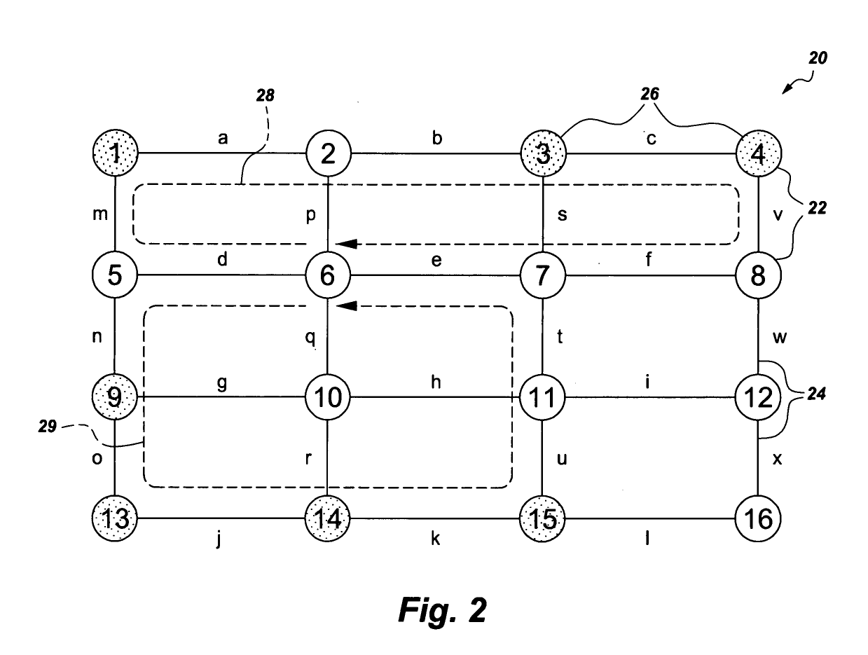

Referring to FIG. 2, a traffic network 20, or road network, is illustrated as a grid having a plurality of locations, or nodes 22, interconnected with a plurality of roadways, or arcs 24. Thus, the task of identifying the destinations for the routing method involves simply identifying the locations in the traffic network that must be visited for a given task. In a delivery route, for example, the destinations are the customers to whom a delivery must be made. Using a delivery service as an example, nodes 1, 3, 4, 9, 13, 14, and 15 are customer nodes 26 (shown shaded). The problem becomes how to most efficiently perform required deliveries to each of the customer nodes 1, 3, 4, 9, 13, 14, and 15. This sort of problem is often referred to as a traveling salesman problem. The problem includes consideration of the delivery order among the customers, traffic that will be encountered during the course of making the deliveries. According to the present invention, a capacity constraint such as a delivery vehicle capacity is considered as well.

Consider then the problem of delivering computers to customers at customer nodes 1, 3, 4, 9, 13, 14, and 15, from a warehouse located at node 6. Simplicity suggests a routing, beginning and ending at the warehouse node 6, such as {6,1,3,4,9,13,14,15,6}; thus node 6 in this example tour is the starting point and the final destination point. Such a routing, beginning and ending at the same point and visiting one or more destinations, is generally referred to as a tour. The simplest tour simply includes all destinations in any ordering. However, assuming that a delivery truck can carry fifty (50) computers, it can be seen that, if customer 1 needs (10) computers, customer 3 needs (25) computers, customer 4 needs (8) computers, and customer 9 needs (20) computers, the vehicle capacity dictates that in the given order of customers {6,1,3,4,9,13,14,15,6}, the delivery vehicle can only serve customers {1,3,4} before returning to the warehouse node 6 to reload. Thus, a first tour 28 (including the set of customer nodes {6,1,3,4,6}) fails to complete the entire delivery requirement, and at least one additional tour must be considered. A second tour 29 (including the set of customer nodes {6,9,13,14,15,6}) might suffice if the requirements of customers 9,13,14, and 15 can be met within the capacity constraint of the delivery vehicle. It can be seen, then, that to serve any given number of customers requires that one or more tours be generated in view of a capacity constraint.

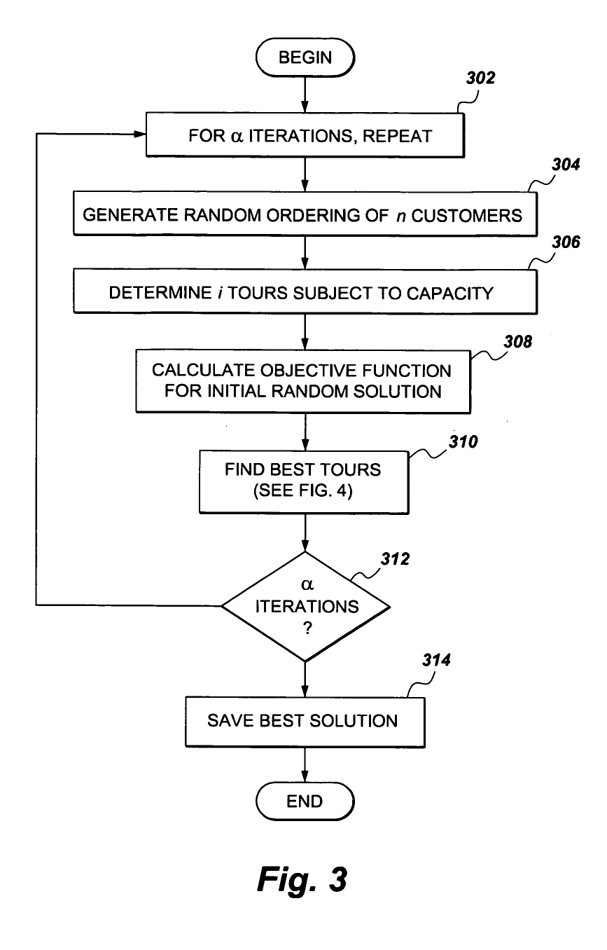

Referring to FIG. 3, tours are determined by an algorithm that is repeated for a selected number of iterations (step 302), each of the iterations beginning with a random ordering of customers. Initially, all customers are ordered randomly (step 304). The customers are then added, according to this random ordering, to one or more tours (step 306). For example, if the initial random ordering of the customers 1,3,4,9,13,14,15 is 15,4,14,9,13,3,1, then the customers are added to a first tour in sequence {6,15,4,14 . . . } until the capacity constraint is met, creating a first tour. If the capacity constraint is met in the first tour, a second tour is begun, with customers added until the capacity constraint is again met. This continues until all customers have been added to a tour.

Once an initial solution, that is an initial set of tours, has been determined from the random ordering of all customers, an objective function for the initial solution is calculated (step 308). The objective function is a measure of the quality of the solution. The objective function may be based on any of a number of different elements, such as total distance, time, safety, and so on. The objective function is used to compare subsequent solutions that attempt to improve on the initial solution.

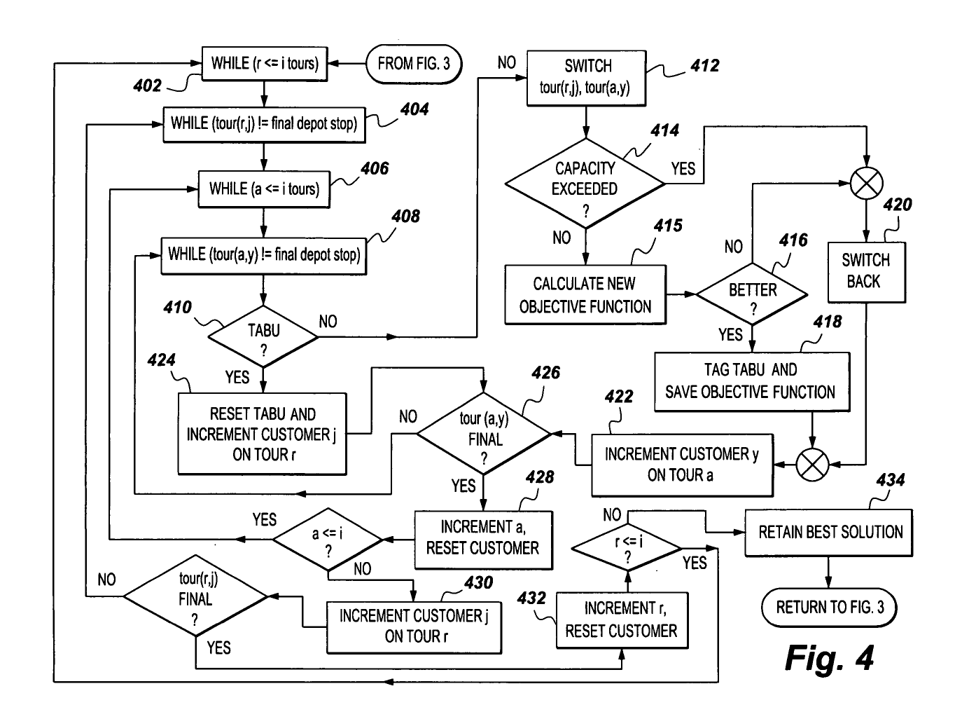

The ordering of customers in the tours is then modified to find improvements (step 310), performing improvement exchanges and employing a tabu search method. In the illustrated method, a type of a 2-opt exchange is employed to seek improvements in the ordering, as shown in FIG. 4; however it should be understood that other opt exchange protocols can be used such as, but not limited to, 1-opt, 3-opt, 4-opt or n-opt, where n is any integer in the range 1 to as many destination points or customers found in a given tour. Once improvements to the initial random solution have been identified, and the best improvement saved, by the improvement exchange and tabu search process, additional iterations of the ordering and tour generation process are performed (beginning again at step 304 with a new initial random ordering of customers). On completion of a specified (or user-definable) number α of iterations, the best solution of all of the iterations is identified and saved (step 314).

Referring to FIG. 4, the improvement exchange and tabu search process is discussed in greater detail. The improvement exchange and tabu search proceeds with several nested loops, beginning by performing a series of steps (the outermost of the nested loops) for each of the tours. Given i tours, each tour having j customers, and wherein tour (i,j) refers to customer j on tour i, the process continues for each tour r, while r<= (less than or equal to) i (at 402). The process loops again, for a tour (r,j), evaluating each customer position, until the final stop of the tour (“warehouse” or “depot”) is reached, repeating while tour (r,j)!= (not equal to) final depot stop (at 404). A next nested loop continues for a potential new, improved tours, while a <i (at 406), testing a node tour (a,y) for improvement while the node tour (a,y) is not the final depot stop (at 408). On checking for improvements at a node tour (a,y), if a tabu criterion is not met (tested at 410), the process continues to seek improvements by performing an improvement exchange, switching tour (r,j) with tour (a,y) (step 412). The tabu criteria will be discussed further below. At the present, it is sufficient to note that on the first cycle through this innermost loop, the tabu criteria is not yet met.

On switching tour (r,j) with tour (a,y), the potential new tours a and r are tested against the capacity constraint (at 414). If the capacity constraint is not exceeded, the objective function for the new tours are determined (at 415). If the switch is an improvement (at 416), the new tour ordering is marked as “tabu” and saved, along with the improved objective function (step 418). If the switch is not an improvement, or if the capacity constraint was exceeded at 414, the switch is reversed, putting tour (r,j) and tour (a,y) back to their positions as before the switch (step 420). On completing the switch and evaluation (steps 412 to 420), customer y on tour a is incremented, and the innermost loop (while the node tour (a,y) is not the final depot stop, at 408) is continued until y has reached the final depot stop. Similarly, if the tabu criteria were met at step 410, the tabu duration is reset, customer j on tour r is incremented (step 424), and the innermost loop continued.

At this point, it can be recognized that the tabu criteria is met when an improvement in the tour ordering, as measured by the objective function, is achieved. The algorithm stops performing improvement exchanges for the position designated tabu for at least a short time interval. The tabu duration, that is the time period during which an “improved” positioning of a given node in a tour is held constant, may be limited or it may be indefinite. In the preset algorithm, the tabu duration is a single cycle through the nodes of a tour. It can be seen that, once an improvement on a position tour (r,j) is found and the tabu duration begun, the tabu duration is ended at the next cycle as j is incremented.

The innermost loop completes when the final depot of tour (a,y) is reached (at 426), whereupon a is incremented and the customer reset (step 428), continuing the loop (while a<i, 406) until a has reached i. At this point, customer j on tour r is incremented (step 430) as the loop (while tour (r,j)!= final depot stop, 404) continues. When tour (r,j) reaches the final depot stop (of tour r), r is incremented (step 432) until all of the i tours have been evaluated. The best solution is retained (step 434), and the tour generation and ordering process resumes at step 312.

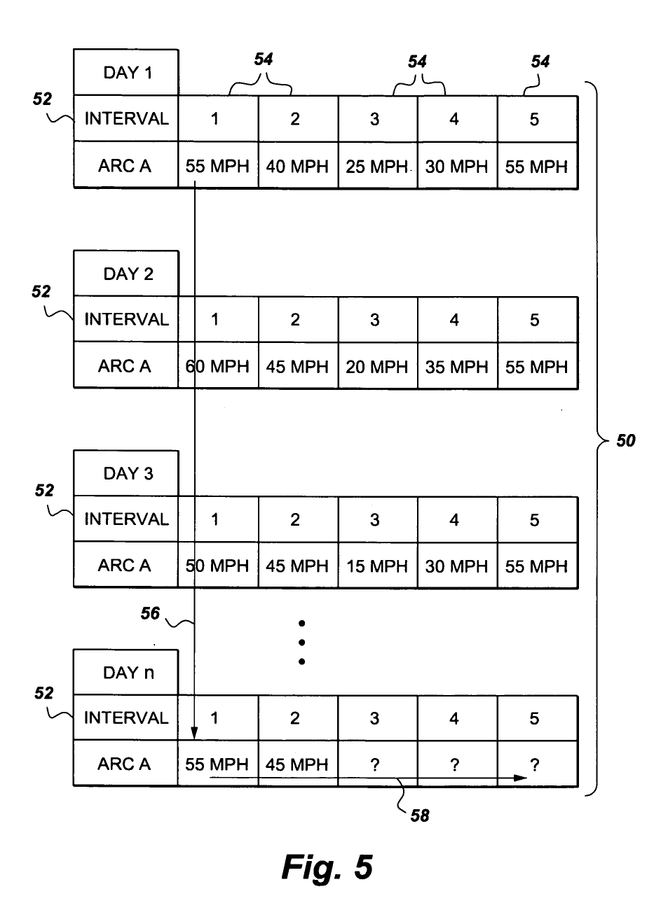

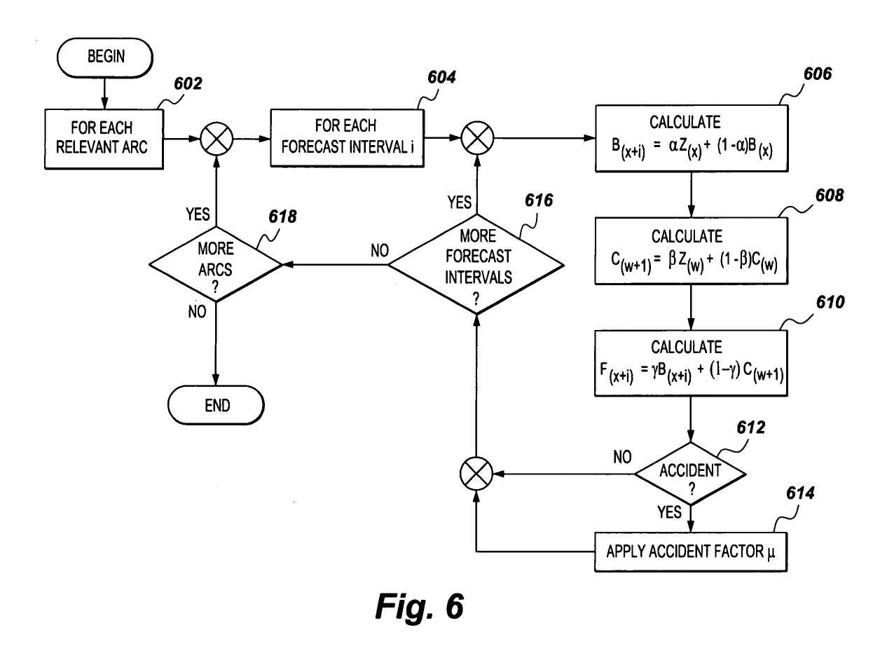

Returning briefly to FIG. 1, the next aspect of the routing method 10 according to the present invention is to forecast traffic conditions along the roadways in the travel network, for the time periods during which the destinations will be visited (step 16). The primary traffic condition considered, in the present embodiment, is the travel speed for a vehicle traversing an arc in the traffic network. A multiple time series forecasting method, that includes a correction for traffic accident or other anomalous events, is described with reference to FIGS. 5 and 6.

Time series analysis uses a series of historical data points to predict future values for the data, based on an assumption that a trend in the historical data will continue into the future. In consideration of traffic conditions along a roadway, a data point may be a time interval during the course of a day, such as the hour between 1 pm and 2 pm in the afternoon. Obviously, each day can be divided into many such intervals. Thus, one possible time series of interest might be consecutive intervals within a single day. Another time series of interest might include a given interval, repeated over the course of several consecutive days, or repeated over the course of, for example, each Wednesday of several consecutive weeks.

Referring to FIG. 5, a dataset 50 of several days 52 is shown, wherein each of the days 52 is divided into a number of intervals 54. Note that a first series 58 exists consisting of the consecutive intervals 54 in a day 52, and a second series 56 exists consisting of intervals 54 repeated over the course of several days 52. For any given interval iₙ, either of these series 56, 58 can be used to predict a future interval i₍ₙ₊₁₎. Because traffic conditions are influenced both by intraday factors (rush hour periods tend to occur daily at predictable hours; a lunch hour likely sees an increase in traffic in certain areas, etc.) and day-to-day factors (Friday traffic patterns likely differ from Wednesday traffic patterns because of an increase on a Friday afternoon of traffic leaving town for a weekend trip, while Sunday traffic generally lacks the typical commuter rush hours), it makes sense to use both time series 56, 58 in traffic predictions.

Data available for the traffic predictions includes both historical data and actual, real-time data for a present time interval. Because of the availability of numerous sources of real-time data, including video cameras on major traffic routes, traffic sensing loops embedded into roadways, traffic reports based on visual observation, telemetry including GPS position and velocity reporting directly from properly equipped vehicles, a reasonably accurate measurement of traffic conditions is available in a real-time, or a “present time” basis. Thus, the traffic condition forecasting can use, as a most recent “historical” data point, present real-time conditions. And where real-time conditions are not available, historical proxies can be used for estimation. Each time series, thus, includes a number of historical values and a present time sample.

A time series analysis technique known as exponential smoothing is used. Exponential smoothing is based on the formula:
B₍ₓ₊₁₎=αZ₍ₓ₎+(1−α)B₍ₓ₎
wherein α is a smoothing parameter between zero and one, B₍ₓ₊₁₎ is the forecast interval, Z₍ₓ₎ is the present real-time traffic measurement, and B₍ₓ₎ is the previous forecast value. It can be recognized that, because the forecast value B₍ₓ₊₁₎ is based in part on a previous forecast value B₍ₓ₎, each forecast value contains a “memory” of previous data points. When an initial forecast B₍₀₎ is made without the benefit of previous forecast data, the present real-time traffic measurement Z₍ₓ₎ is used, giving
B_{(0)i =αZ}₍₀₎+(1−α)Z₍₀₎

Because the data history of both the real-time and forecast data components is inherently retained by the forecast value, it becomes unnecessary to retain a complete data history of either the real-time or forecast data values. All that must be retained is the most recent forecast value; fresh real-time data will be used for each new and subsequent forecast.

Turning now to FIG. 6, a time series forecast for traffic conditions that includes a correction for traffic accident or other anomalous events is discussed in greater detail. Beginning at 602, a forecast is performed for each relevant arc in the road network. This may include only the arcs that will be considered later in finding routes between the customers, or tour stops, previously determined. Alternatively, in a system providing traffic information and routing services to multiple customers, this may include all of the arcs in a road network. For each arc considered, the forecast is repeated for each forecast interval. The traffic forecast for each forecast interval begins by performing an exponential smoothing forecast for a first time series B, the intra-day series of time intervals, using the formula B₍ₓ₊ᵢ₎=αZ₍ₓ₎+(1−α)B₍ₓ₎ described above (step 606), wherein α is a smoothing parameter, B₍ₓ₊ᵢ₎ is the forecast for interval i for the first series B, Z₍ₓ₎ is the present real-time traffic measurement, and B₍ₓ₎ is the previous forecast value in the series B. Next, an exponential smoothing forecast is performed for a second time series, C, a series of same time intervals across several days, using the formula C_{(w+1)}=βZ_{(w)}+(1−β)C_{(w)} (step 608), wherein β is a smoothing parameter between zero and one, C_{(w+1)} is the forecast interval next in the second time series, Z₍ₓ₎ is the most recent traffic measurement, and C_{(w)} is the previous forecast value for the second time series. This inter-day forecast procedure is repeated for all future time intervals.

With a forecast generated for each of the two time series of interest, the two forecast values are combined to produce a weighted average (step 610) with the formula
F₍ₓ₊ᵢ₎=γB₍ₓ₊ᵢ₎+(1−γ)C_{(w+1)}
wherein γ is a weighting factor between zero and one. F(x+i) is the final time-series traffic forecast. C_{(w+1)} is the traffic forecast for the second time series that corresponds to the appropriate interval i. However, at this point the traffic forecast may still be modified before use by applying a correction if a known accident or other anomalous traffic condition is known. If an accident, or other anomalous traffic condition, is reported or known (determined at 612), the forecast traffic condition F₍ₓ₊ᵢ₎ is modified by an accident factor p (step 614).

A basic accident model assumes that, when an accident occurs, traffic speed slows progressively over a period of time to a minimum, and then the traffic speed gradually increases over another period of time, creating essentially a three-interval profile, having a first interval of slowing traffic speed, a second interval of generally minimum traffic speed, and a third interval of traffic speed increasing to normal. A basic parabola approximates the shape of a graph of traffic speed during a traffic accident. Thus, the accident factor μ is determined by a quadratic equation of the form μ=ax²+bx+c, where a is negative, and μ is greater than 0.

Once all forecast intervals (determined at 616) have been determined for all arcs (determined at step 618), the traffic forecasting is completed. Returning briefly to FIG. 1, with the traffic conditions forecast for the relevant arcs in the road network, the next aspect of the routing method 10 according to the present invention is to determine optimal routings between the destinations of each of the tours, for the actual time of day that each of the roadways will be traveled in order in each of the tours (step 18). This involves, for each of the tours identified previously, determining an optimal route between each of the points on the tour, from a depot to a first customer, first customer to second customer, and so forth.

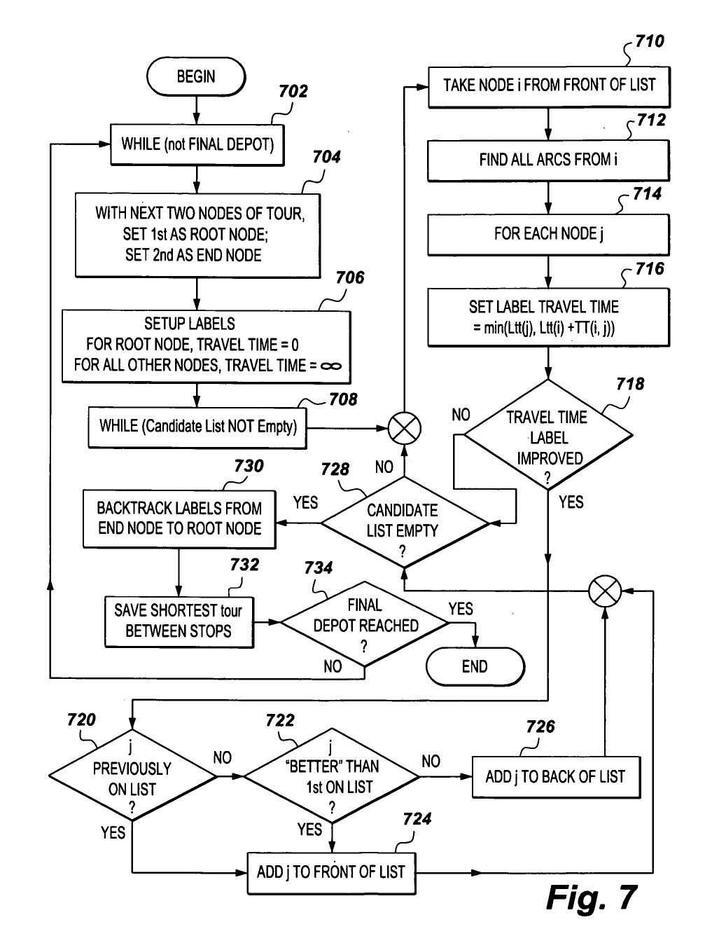

Turning now to FIG. 7, a label correcting method for finding the optimal routes is described. For a tour, the method is performed for each consecutive pair of destinations in the tour, in a loop while (not the final depot) (at 702). Taking, at each cycle through this outer loop, the next pair of nodes, the first of the pair is designated the root node, and the second is designated the end node for the route segment connecting the destinations (step 704). Note that there may be many nodes in the road network between the root node and the end node. Labels are initialized for the nodes (step 706), with a travel-time label set to zero for the root node, and the travel-time label for all other nodes set to infinity, or to a maximum representable value, or a similar tag designating an as yet unexplored node. Placing the root node on the candidate list initializes the candidate list. An inner loop repeats while the candidate list is not empty (at 708). Taking a node i from the front of the candidate list (step 710), all arcs leaving the node are identified (step 712), where each arc leads to a node j. For each of the nodes j (at 714), a predecessor label is set to identify the connected node i, and a travel-time label for a node j is determined as the minimum of the current travel-time label for j, and the current travel-time label for i plus the arc length to the node j (step 716).

Note that at this point the traffic conditions determined previously are considered in determining the arc length, stating the arc length in terms of travel time (a function of actual distance or length of the arc and travel speed) rather than simply in terms of actual distance. If the travel-time label for the node j is improved (decided at 718), the node j is placed onto the candidate list, either at the front or the back of the candidate list. If j was previously on the candidate list (at 720), it is placed now at the front of the candidate list (step 724). However, if j was not previously on the candidate list, it is placed at the front of the candidate list if the new travel-time label for j is now “better” (a shorter time) than the travel-time label for the first node on the candidate list; otherwise j is placed at the back of the candidate list (step 726). After each of the nodes j, reachable by the arcs leaving the current node i, have been evaluated, the process continues, returning to step 710 as long as the candidate list is not empty. Once the candidate list is empty (at 728), the shortest route is found between the root node and the end node by beginning with the end node and backtracking along the intervening nodes, following the predecessor node labels. This shortest routing is saved (step 732) for the route between the pair of tour destinations, and the loop (while not the final depot, 702) repeats until the final depot is reached (at 734), when the algorithm terminates.

Thus, the routing method of the present invention solves a routing problem wherein multiple destinations are to be visited in a timely and efficient manner. The destinations are ordered into one or more tours by a traveling salesman problem solving algorithm that includes certain constraints. Once the destination ordering is determined, traffic information is used to forecast travel conditions, such as traffic flow speeds, along the roadways interconnecting the destinations. Using the forecast travel conditions, a shortest path algorithm is used to find optimal routes between each of the destinations, completing the routing solution.

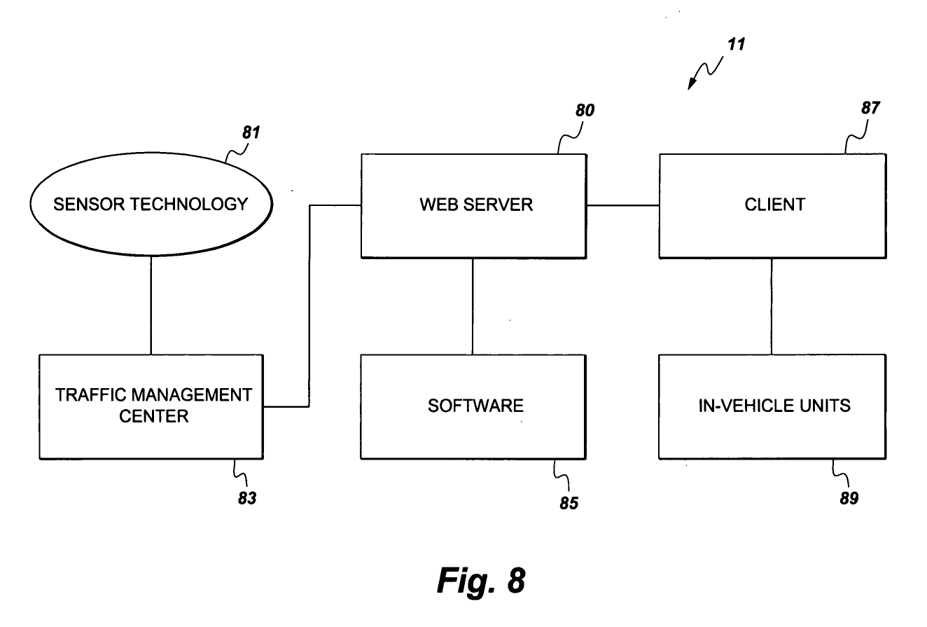

A routing system embodies the routing method in a computer system. The routing system may be a localized, or stand-alone, system, or an Internet system providing a service for numerous network clients. The routing system may be combined with Global Positioning System technology to determine user locations. In addition, the routing service may be delivered to mobile users via wireless technologies. Turning now to FIG. 8, a routing system 11 providing an Internet service is shown. A web server 80 is loaded with computer software 85 to implement the routing method 10. In the illustrated configuration, the web server 80 is in communication with a traffic management center 83 to obtain traffic information for a traffic network that is served by the web server 80. The traffic management center 83 receives traffic inputs from a variety of traffic sensors employing diverse sensor technology 81 to report real-time traffic conditions. The web server 80, along with the computer software 85, employ the routing method described above to generate a routing solution for clients 87 of the web server 80. The clients 87 may include, or may be in communication with in-vehicle units 89 to provide the routing information directly to the vehicle drivers. It can be recognized that many variations of this general architecture for a routing system 11 may be employed.

The web server 80 includes, or is in communication with, a database that stores a representation of the traffic network, the traffic network being represented as a network of nodes and interconnecting arcs. The database additionally may store historic traffic information, including historic or previous traffic forecasts.

It is to be understood that the present invention is not limited to the embodiments described above, but encompasses any and all embodiments within the scope of the following claims.

I claim:

1. A routing method to find efficient routings to reach destinations in a traffic network, the traffic network having a plurality of nodes interconnected by a plurality of roads, the routing method comprising the steps of:
(a) selecting a starting point and at least one destination point in the traffic network;
(b) ordering the starting point and at least one destination point into at least one tour, wherein the tour begins at the starting point and includes at least one destination point;
(c) forecasting traffic conditions for the roads in the traffic network; and
(d) for each tour, generating a routing using the forecast traffic conditions.

2. The routing method according to claim 1, wherein at least one tour is generated by adding destination points to a tour until a capacity constraint is met.

3. The routing method according to claim 1, wherein at least one destination point is subject to a time-window constraint.

4. The routing method according to claim 1, wherein at least one tour is served by at least one vehicle.

5. The routing method according to claim 1, wherein each tour begins and ends at the starting point.

6. The routing method according to claim 1, wherein step (b) includes the steps of:
generating an initial random order of destination points, and
generating an initial set of tours by allocating the destination points in the initial random order to one or more tours, wherein each tour is limited by a capacity constraint.

7. The routing method according to claim 6, further comprising the step of calculating an objective function to assess a quality of the initial set of tours.

8. The routing method according to claim 6, further comprising the step of making improvements to the initial set of tours to generate an improved set of tours.

9. The routing method according to claim 8, wherein step (b) utilizes an n-opt exchange algorithm within a tabu search algorithm to generate an ordering.

10. The routing method according to claim 1, wherein step (b) utilizes a tabu search algorithm to generate an ordering.

11. The routing method according to claim 1, wherein step (b) utilizes a branch and bound technique to generate an ordering.

12. The routing method according to claim 1, wherein step (b) utilizes a branch and cut technique to generate an ordering.

13. The routing method according to claim 1, wherein step (b) utilizes an ant algorithm to generate an ordering.

14. The routing method according to claim 1, wherein step (b) utilizes a constraint programming technique to generate an ordering.

15. The routing method according to claim 1, wherein step (b) utilizes an annealing technique to generate an ordering.

16. The routing method according to claim 1, wherein step (b) utilizes a genetic algorithm to generate an ordering.

17. The routing method according to claim 1, wherein step (c) comprises the steps of:
collecting current real-time traffic information, and
using the current real-time traffic information to generate a traffic conditions forecast of traffic conditions for a future time interval.

18. The routing method according to claim 17, wherein step (c) further comprises the steps of:
providing previous traffic condition information, and
performing a time-series analysis using the previous traffic condition information along with the current real-time traffic information to generate the traffic conditions forecast.

19. The routing method according to claim 17, wherein the previous traffic condition information comprises a previous traffic conditions forecast.

20. The routing method according to claim 1, wherein step (c) further comprises the steps of:
collecting historical traffic information,
collecting real-time traffic information,
modeling traveler behavior, and
performing a dynamic traffic assignment using the historical traffic information, real-time traffic information, and traveler behavior models to generate the traffic conditions forecast.

21. The routing method according to claim 1, wherein step (d) utilizes a label correcting algorithm to generate the routing.

22. The routing method according to claim 1, wherein step (d) utilizes a label setting algorithm to generate the routing.

23. The routing method according to claim 1, wherein step (d) utilizes an A* algorithm to generate the routing.

24. The routing method according to claim 1, wherein step (d) utilizes a label correcting algorithm to generate the routing, further wherein the label correcting algorithm considers the cost of traversing each arc in the traffic network to determine the routing.

25. The routing method according to claim 24, wherein the cost is a function of an arc length and a traffic condition.

26. The routing method according to claim 25, wherein the traffic condition is the travel speed for a vehicle on an arc.

27. A routing system for finding efficient routings to reach multiple destinations in a traffic network, said traffic network having a plurality of nodes interconnected by a plurality of roads, said system comprising:
a database storing a representation of said traffic network;
means for selecting a starting point and at least one destination point in said traffic network;
means for ordering said starting point and at least one destination point into at least one tour, wherein said tour begins at said starting point and includes at least one destination point;
means for forecasting traffic conditions for the roads in said traffic network; and
means for generating a routing for each tour using said forecast traffic conditions.

28. The routing system of claim 27, further comprising means for receiving current real-time traffic information for said traffic network.

29. The routing system of claim 27, further comprising a database storing historical traffic information for said traffic network.

30. The routing system of claim 27, further comprising at least one remote terminal operable for user entry of said starting point and at least one destination point.
